(19) United States
(12) Patent Application Publication
(10) Pub. No.: US 2012/0009376 A1
(43) Pub. Date: Jan. 12, 2012

(54) Vacuum Insulation Panel, Insulated Masonry Structure Comprising Same, And Method Of Construction

(76) Inventor: Stanley J. Rusek, JR., The Woodlands, TX (US)

(21) Appl. No.: 12/834,065

(22) Filed: Jul. 12, 2010

(51) Int. Cl. B32B 3/18; B32B 15/14; B32B 7/08; B32B 5/02; B23P 17/00

(52) U.S. Cl. 428/69; 29/897.32

(57) ABSTRACT

A vacuum insulation panel is provided comprising a core with a plurality of stacked non-woven organic free glass fiber sheets, plies, or net shape one piece glass fiber core and a vacuum sealed enclosure containing the core. The fiberglass sheets are formed from glass fibers having a nominal diameter of about 1.5-3.0 microns and the enclosure is formed from an annealed stainless steel foil. The vacuum insulation panel has a thickness of from about 1 to 2.5 inches and an insulation value R of at least 56.8 at moderate vacuum levels between about 1.0E−02 to 1.0E+01 mTorr. In addition, a method of manufacturing same is provided, as well as a method of construction, wherein the vacuum insulation panel is disposed between two walls in the gap therebetween, and preferably a filler material, such as aerated concrete, fiberglass, foam, etc., is disposed in the gap so as to partially or fully encase the vacuum insulation panel.

### BACKGROUND OF THE INVENTION

1. Field of the Invention

The present invention relates in general to insulation used in the building construction industry, and, more particularly, to vacuum insulation panels which can provide superinsulation for buildings and the like. In addition, a masonry structure comprised of the vacuum insulation panel of the present invention is provided, as well as a method of constructing insulated masonry structures. The vacuum insulation panels of the present invention can provide an effective R value of over 50 U.S. below 2.0 inches, and provide a life expectancy of one hundred years or more.

2. Description of the Related Art

Vacuum insulation panels of conventional construction have been used to clad the exteriors of buildings and homes at various locations, and insulate building facades in Germany and elsewhere. Conventional construction of vacuum insulation panels includes the use of aluminum foil laminates or metallized polymer laminates that employ heat or adhesive sealing to form a semi-airtight or outgassing enclosure for the various filler materials that exist in the prior art. These filler materials include fiberglass, silicas, aerogels, foams, and other mixtures.

In the United Kingdom (UK), homes are built primarily with an interior masonry block wall construction and an exterior brick wall. The interior and exterior walls are tied together with plastic, ceramic, or steel masonry ties for structural reasons. Generally, there exists a narrow 4-inch gap between these two walls that can be insulated. It is normally either left empty, or insulated with traditional insulators such as mineral fiber or glass fiber batting, loosefills, sprayed foam, or boards. Since the R-value of these walls depends on the summation of the R-values of the constituent materials (which themselves are dependent on thickness as well as their individual thermal resistances), there is a limit on the amount of thermal resistance possible from the constrained thickness walls in these homes.

The UK (England/Britain and others), however, has legislated that new homes built there must attain an energy level of net zero by the year 2016, creates an urgent need for the present invention. Unfortunately, traditional insulators, as discussed above, are incapable of meeting these newly mandated insulative properties. More specifically, although it is possible to insulate these walls somehow with conventional materials, the required thickness of these materials is too high to be practical or cost effective. For example, to achieve an R 56.8 US in a 4-inch thick gap would require traditional fiberglass insulation of 3.2 to 4.2 R/in to be 14 to 18 inches thick, or foam (for foam at 5.0 to 7.0 R/in that is 8 to 12 inches) to be 8 to 12 inches thick. Thus, the new UK insulation standard requires a redesign of the home, which would likely result in loss of floor space in order to accommodate the insulation.

Traditional vacuum insulation panels (VIP's) provide a much greater R value (per inch) than fiberglass or foam insulation. For example, U.S. Pat. No. 5,869,407 describes a vacuum insulation panel formed of stainless steel less than 7 mils thick containing a fiberglass batting or ply. The panel is evacuated to a pressure of less than 20,000 mTorr, preferably 0.1 mTorr to 1 mTorr. This patent discloses that the stainless steel insulation panel has an R value of 20. However, traditional VIP's have not been previously used to insulate masonry walls, such as the type commonly constructed in the (UK). This is based on various engineering problems/issues involved with installing VIP's in masonry structures, including fragility, and the instability of R value over time of traditional vacuum insulation panels. In particular, VIP's of conventional construction (as described previously) suffer from a number of weaknesses as follows:

First, the vacuum envelopes or enclosures are not truly hermetic or airtight or non-outgassing, as is required for the long life of a building. For a vacuum insulation panel to function as a superinsulator (a better insulator than normally occurs in nature or conventional insulations), air or gas must be removed to a sufficient level to allow the core to superinsulate. Namely, the vacuum level must be maintained over time.

Currently VIP's use multilayered vapor deposited aluminum metallized film or aluminum foil/polymer laminates with an organic heat-sealing layer. These structures suffer from (1) small pinhole defects in the film's gas barriers caused by stresses, bending, or are present in the metal layer(s) to begin with or of insufficient vaporized metal thickness such that ambient air and water vapor will leak into the core of the vacuum insulation panel and diminish the vacuum; and (2) the organic molecules (polymers) have sufficient vapor pressure to diminish the vacuum via outgassing. Diminishing the vacuum (increasing pressure) results in the loss of thermal resistance performance.

These weaknesses in the envelope of traditional VIP's serve to make these types of VIP's unstable, and the superinsulating effect thereof diminishes over time, even though “fixes” such as getters are placed within the VIP. Thus, it is very likely that these types of VIP's will have much shorter lifetimes than the building in which they are disposed. Accordingly, the time instability of the current generation of VIP's in the marketplace has blocked acceptance from the builders and mortgage lenders since mortgage lenders in the UK require that building materials display a service life of over 60 years.

Second, if the envelope of the VIP is made from a thicker more stable near zero pinhole aluminum foil laminate, then thermal performance will suffer due to the “thermal bridging” edge effect. The purpose of any VIP is to reduce the flow of heat from hot to cold. The heat flow path through any VIP is considered to have 2 main paths, i.e., through the edge, and through the main core. The envelope must not allow too much of the heat to flow from hot to cold, or else the effective performance of the VIP will be compromised. Heat always takes the path of least resistance and typically follows the material with the highest thermal conductivity. It is a 3 dimensional phenomenon and requires finite element analyses to model and calorimeter testing to validate.

Typical heat flows through traditional VIP's made with aluminum foil laminate envelopes can exhibit longer life spans, but typically less than 20 years. However, such VIP's have poor effective performance since the thermal resistance of the edge is much less than for the thermal core. Reducing the thickness of the foil from 1.0 mils (pinhole free) down to 0.35 mils (rife with pinholes) can help reduce the thermal bridging effect. However, the life of the panel then suffers due to the increased number of pinholes in the foil. Thus, it is an object of the present invention to provide a VIP having a very long life span possessing a low thermal bridging effect. As the mathematical product of the envelope thermal conductivity times the edge thickness (K×T) is reduced, thermal thermal bridging effects will reduce correspondingly and the effective R will increase. In the limit as K×T approaches zero the effective R will equal the COP R. COP R refers to the panel R at the center of the panel.

Third, the delicate nature of either aluminum foil or metallized foil laminates used in conventional VIP envelopes requires expensive and thicker secondary protective enclosures in order to resist damage during construction. A more robust, lower thermal conductivity envelope material is thus required in order to survive damage from handling, punctures, and dropped tools. Thus, it is another object of the present invention to provide a VIP having a more robust, low thermal conductivity envelope.

Fourth, moisture in the building environment serves to degrade the performance of all conventional VIP's by diminishing the vacuum. Moisture does this by moving through pinholes and weak spots of the envelope metallization, and through the heat seals faster than oxygen or nitrogen in the air. Thus, it is another object of the present invention to provide a VIP envelope which is hermetic and impervious to moisture at a broad range of temperatures. The envelope must also resist corrosion and attack from the various chemicals present in a building environment such as weak acids and alkalis.

Fifth, additional thickness is required of conventional VIP's in order to meet the requirements set down by the UK for 56.8 effective R values in less than 2 inches of thickness. That is, because the R-value per inch of conventional VIP is too low to provide a 56.8 effective R value within 2 inches. The current polymer laminate envelopes cannot maintain or sustain the medium vacuum levels necessary to create the greatest superinsulation effect, e.g. COP R per inch over 70. Typically, traditional VIP's have COP R values per inch ranging between 20 and 45.

The low weaker vacuum levels achievable in conventional VIP's require that very high cost fillers be utilized to superinsulate at these higher pressures (low vacuums). Although high cost fillers, such as aerogels and pyrophoric silicas, are available in traditional VIP's, such VIP's are only utilized in small area insulation, such as appliances, coolers, etc. Using same in construction applications is cost prohibitive and offers lower value than the present invention. Thus, it is a further object of the present invention to provide a VIP for use in construction applications having an effective R value of at least 56.8, which uses low cost insulative materials, does not require extremely high vacuum levels, and can be produced at an economically viable price level.

It is, thus, an object of the present invention to provide an improved VIP possessing the ability to last the life of a building, i.e., one hundred years or more.

It is yet another object of the present invention to provide an improved VIP which is truly hermetic or air tight, so as to provide superinsulation which is more robust and can survive damage from handling, punctures, dropped tools during the installation.

Another object of the present invention is to select the envelope materials and thicknesses based on this parameter and perform FEA to validate the designs. K×T for aluminum foil envelopes is much higher than the present invention.

It is another object of the present invention to provide a VIP envelope that is resistant to attack from chemicals that might be present within the fabric of the building envelope.

### BRIEF SUMMARY OF THE INVENTION

In order to achieve the objects of the present invention, as discussed above, the present inventor endeavored to develop a vacuum insulation panel (VIP) having an insulation value R of at least 56.8, a thickness of less than 4 inches, and a life expectancy of about 100 years. Accordingly, the present inventor discovered the VIP of the present invention, which is composed of a core of glass fiber paper sheets or plies, or net shape one piece glass fiber cores in a sealed vacuum enclosure formed from a stainless steel foil.

Specifically, in a first preferred embodiment of the present invention, a vacuum insulation panel (VIP) is provided comprising:

a core comprised of a plurality of stacked non-woven organic-free glass fiber paper sheets or plies, or net shape one piece glass fiber core and

a vacuum sealed enclosure containing said core, said enclosure being formed from stainless steel foil,

wherein the VIP has an R value of at least 56.8 at moderate vacuum levels of between about 1.0E−02 to 1.0E+01 mTorr absolute pressure, and a panel thickness of from about 1.0 to 2.5 inches.

In a second preferred embodiment, the VIP of the first preferred embodiment above is provided, wherein the core is formed from sheets of wet laid glass fibers or net shape single piece glass fiber core having a nominal diameter of from about 1.5-3.0 microns (most preferred 2.5 microns), said VIP having an insulation value R of from about 56.8-107.

In a third preferred embodiment, the VIP of the first preferred embodiment above is provided, wherein the vacuum sealed enclosure is formed from fully annealed stainless steel foil.

In a fourth preferred embodiment, the VIP of the third preferred embodiment above is provided, wherein the vacuum sealed enclosure is formed from low carbon stainless steel foil.

In a fifth preferred embodiment, the VIP of the fourth preferred embodiment above is provided, wherein the vacuum sealed enclosure is formed from fully annealed stainless steel foil about 0.003 inches thick. In a sixth preferred embodiment, the VIP of the fifth preferred embodiment above is provided, wherein the vacuum insulation panel enclosure is formed from a fully annealed stainless steel grade 201L or 304L.

In a seventh preferred embodiment, the VIP of the first preferred embodiment above is provided, wherein a portion of the vacuum sealed enclosure has a pan shape. This pan shapes is formed by pneumatic forming, using a die with curved edges and corners, whereby to eliminate sharp corners and bends, thus preventing tearing and formation of pin holes in the stainless steel foil.

In an eighth preferred embodiment, the VIP of the seventh preferred embodiment above is provided, wherein a lid is attached to the pan shaped portion of the enclosure by resistance seam welding. The lid can be made from either a simple flat foil cover or a pan shaped foil cover, depending on the desired total VIP thickness or assembly requirements. Pneumatic forming has a depth limit depending on the level of annealing, thickness, or cold working that occurs during pan forming.

In a ninth preferred embodiment, the VIP of the first preferred embodiment above is provided, wherein the vacuum sealed enclosure is formed from fully annealed stainless steel foil having a low carbon content and grade 201L or 304L, said foil being 0.003 inches thick and having a pan shape. This portion or each half of the present invention being pan-shaped (i.e., the pan-shaped portion) of the vacuum sealed enclosure can be formed by pneumatic forming using a die with curved edges and corners, whereby to eliminate sharp corners and bends thus preventing tearing and formation of pin holes in the foil, and a lid being attached to the pan-shaped portion of the enclosure by resistance welding. Laser beam welding is also possible but not preferred.

In a tenth preferred embodiment, the VIP of the second preferred embodiment is provided, wherein the vacuum sealed enclosure is formed from fully annealed stainless steel foil having a low carbon content and grade 201L or 304L, said foil being 0.003 inches thick and being formed into a pan-shaped portion of the vacuum sealed enclosure by pneumatic forming using a die with curved edges and corners, whereby to eliminate sharp corners and bends thus preventing tearing and formation of pin holes in the foil, and a lid either flat or pan shaped being attached to the pan-shaped portion of the enclosure by resistance seam welding.

In an eleventh preferred embodiment, the VIP of the first preferred embodiment above is provided, wherein the stacked glass fiber paper sheets, plies, or net shape single piece glass fiber core has a nominal density in the range of from about 12-18 lbs./ft³ under atmospheric loading, the most preferred density being 16 lbs./ft³

In a twelfth preferred embodiment, the VIP of the first preferred embodiment above is provided, wherein the production process for producing the glass fiber paper sheet, ply, or net shape single piece glass fiber core is water based.

In a thirteenth preferred embodiment, the VIP of the first preferred embodiment above is provided, wherein the glass fibers in the glass fiber paper sheet, ply, or net shape single piece glass fiber core have a diameter of from about 0.4-8 microns.

In a fourteenth preferred embodiment, the VIP of the first preferred embodiment above is provided, wherein the glass fiber paper sheets, plies, or net shape single piece glass fiber core are formed by:
(a) mixing glass fibers with water to form a slurry; and
(b) passing the slurry through a hydropulping machine to shorten the fibers and achieve the proper fiber/water consistency when mixed with water; and
(c) for paper sheets or plies, the water from the slurry is drained therefrom using a headbox with a moving drainage screen causing the fibers to become entangled. The orientation of the entangled fibers is desirably and primarily laminar in that they are aligned substantially parallel to the drainage screen. (Fibers parallel to the screen have desirable higher thermal resistance than fibers perpendicular to the screen). The wet paper is then dried in an oven and rolled up for later use; or
(d) For net shape single piece glass fiber cores the water from the slurry is drained therefrom using an individual drainage screen mold built to the dimensions of the foil pan shape. The fibers become entangled and conform to the shape of the pan as a single piece core. The orientation of the entangled fibers is desirably and primarily laminar in that they are aligned substantially parallel to the local drainage screen mold planes. (Fibers parallel to the local screen mold planes have higher thermal resistance than fibers perpendicular). Mechanical pressure is applied to the wetglass fiber core to further reduce thickness to approach the finished VIP thickness. Air pressure is then applied through a cover screen to the permeable wet core to strip off the majority of the water from the fiber. Finally the nearly dried net shape core is ejected from the mold and dried in an oven and stored for later use.

In a fifteenth preferred embodiment, the VIP of the first preferred embodiment above is provided, wherein the thickness of an uncompressed sheet or ply of fiberglass is about 0.0575 inches, and the thickness of a compressed ply of paper sheet ply of fiberglass is about 0.0375 inches. Similarly, the VIP of the first preferred embodiment above can be provided, wherein the thickness of an uncompressed net shape single piece glass fiber core is, for example, about 1.50 inches, and the thickness of the compressed net shape single piece glass fiber core is about 1.00 inches.

In a sixteenth preferred embodiment, the VIP of the first preferred embodiment above is provided, wherein said core after being placed into the welded foil envelope can then be heat cleaned in a conventional oven at a temperature of from about 400-600° F. for sufficient time ranging between 10 minutes and 30 minutes to drive off water and/or organic impurities. The water and/or organic impurities can escape from the core and interior pan surfaces through the open sealing port previously punched into the lid.

In a seventeenth preferred embodiment, the VIP of the sixteenth preferred embodiment above is provided, wherein the panel of the first preferred embodiment is removed from the oven and placed while still hot into a vacuum chamber and is evacuated to a pressure below about 1.0E−01 mTorr, most preferably below 1.0E−02 mTorr. Preferably the temperature of the panel is at or above 250° F. during pumpdown. After sufficient pumpdown time has occurred, the open sealing port is then closed. Pumpdown time will depend on many factors, the size of the chamber and number of panels therein, and the amount of material that outgassed from the open sealing port. Typically a preferred pumpdown time is in the order of 5 to 20 minutes. The sealed panel can then be removed from the vacuum chamber, allowed to cool to ambient temperature, and performance tested.

In an eighteenth preferred embodiment, the VIP of the first preferred embodiment above is provided, wherein palladium oxide (PdO) is incorporated into the panel to control any hydrogen that may outgas from the welds of the stainless steel enclosure and from the annealed stainless steel foil. The hydrogen is converted by the PdO to water and is then further scavenged by getters.

In a nineteenth preferred embodiment, the VIP of the first preferred embodiment above is provided, wherein physical and/or chemical getters having high specific surface area adsorbents and/or absorbents are installed in the core materials (i.e., the stacked non-woven organic-free glass fiber paper sheets, plies, or net shape single piece glass fiber core) to scavenge water vapor or other gases that may outgas during the life of the panel. The clean dry glass fibers in the core themselves serve as a gettering agent. While low in specific surface area compared to true getters (0.25 sq meters per gram), a typical panel may contain upwards of 1100 square meters of glass surface area. This phenomenon serves to improve the control of water vapor from diminishing the vacuum level in the present invention. Glass surfaces have a large affinity for water and form a strong chemical bond, thus serving to stabilize the vacuum level.

In a twentieth preferred embodiment, the VIP of the first preferred embodiment above is provided, wherein outer edges of the panel at welds are coated with a layer of insulating foam to minimize heat flow and protect from damage.

In a twenty-first preferred embodiment, a method of producing a vacuum insulation panel is provided comprising:

(a) providing a core comprised of a plurality of stacked non-woven organic free fiberglass paper sheets, plies, or net shape single piece glass fiber core with entangled laminar oriented glass fibers;

(b) introducing said core into a pan-shaped enclosure formed from stainless steel foil; and

(c) heating said enclosure to heat clean the core and pan interior surfaces; and

(d) evacuating and sealing said enclosure.

In a twenty-second preferred embodiment, the method of the twenty-first preferred embodiment is provided, wherein said core is heated prior to being inserted into said pan-shaped enclosure.

In a twenty-third preferred embodiment, the method of the twenty-first preferred embodiment is provided, wherein palladium oxide and a physical desiccant getter and or chemical getter is inserted into said pan-shaped enclosure prior to evacuating and sealing said enclosure.

In a twenty-fourth preferred embodiment, the method of the twenty-first preferred embodiment is provided, wherein said core is heated to a temperature of between about 400-600° F.

In a twenty-fifth preferred embodiment, the method of the twenty-second preferred embodiment is provided, wherein said enclosure is evacuated to a pressure of between about 1.0E−02 to 1.0E−01 mTorr.

In a twenty-sixth preferred embodiment, the method of the twenty-first preferred embodiment is provided, wherein said glass fibers have a nominal diameter of from about 2.0-3.0 microns, preferably 2.5 microns.

In a twenty-seventh preferred embodiment, the method of the twenty-first preferred embodiment is provided, wherein the vacuum insulation panel is rectangular or square-shaped, and has a thickness of from about 0.125-3.00 inches.

In a twenty-eighth preferred embodiment, a method of construction is provided, comprising disposing the VIP of the first preferred embodiment above between two adjacent masonry walls having a gap therebetween. Any substantial flat panel shape is possible, round, oval, trapezoidal, parallelogram, hexagonal, or corner shaped.

In a twenty ninth preferred embodiment, the method of construction of the twenty eighth preferred embodiment above is provided, further comprising disposing a filler material within the gap, so as to partially or fully encase the VIP therein.

In a thirtieth preferred embodiment, the method of construction of the twenty ninth preferred embodiment above is provided, wherein the filler material is one or more of aerated concrete, concrete, brick, foam insulation, plywood, building exterior or interior facades.

In a thirty-first preferred embodiment there is provided in the first preferred embodiment a vacuum insulation panel having a one piece wet molded glass fiber core.

### BRIEF DESCRIPTION OF THE SEVERAL VIEWS OF THE DRAWINGS

FIG. 1A is a cross-sectional side-view of a vacuum insulation panel of the present invention, illustrating the core containing multiple layers of non-woven organic free fiberglass paper sheets or plies in an annealed stainless steel foil enclosure.

FIG. 1B is a cross-sectional side-view of a vacuum insulation panel of the present invention, illustrating the core containing net shape single piece glass fiber core in an annealed stainless steel foil enclosure.

FIG. 2 is an exploded view showing the entangled laminar orientation of glass fibers in the fiberglass paper sheets, plies, or net shape core used in the vacuum insulation panels of the present invention.

FIG. 3 is a graph showing the insulation value R per inch versus pressure in mTorrs for fiber cores of various weights/ft³ when used in the vacuum insulation panel of the present invention, when measures at the center of the vacuum insulation panel.

FIG. 4 is a graph illustrating theoretical R value vs. pressure for the vacuum insulation panel of the present invention (top curve) vs. test data from two prior art vacuum insulation panels (lower curves).

FIG. 5 is a partial cross-sectional view of a masonry structure incorporating vacuum panels of the present invention having the vacuum panel of the present invention disposed gaps between masonry side walls, and encased in aerated concrete, and also positioned between the roof and ceiling.

### DETAILED DESCRIPTION OF THE INVENTION

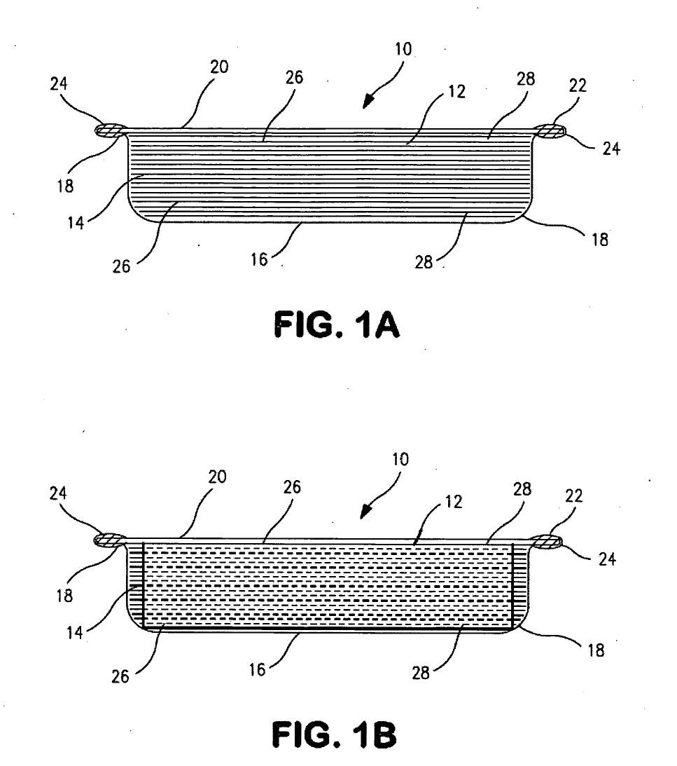

The present invention is described in terms of a vacuum insulation panel which is particularly suitable for use in the construction industry. This insulation panel can be formed in any shape although for illustration purposes panel 10 is shown rectangular in shape. As illustrated in FIG. 1A, an insulation panel shown generally at 10 produced according to the present invention has a core 12 comprised of multiple stacked layers of non-woven organic free fiberglass sheets or plies 14. In a preferred embodiment, as illustrated in FIG. 1A, vacuum insulation panel 10 is formed from two stainless steel foil sections, viz. a first pan-shaped section 16 having rounded corners 18, and a second pan of equal or shallower depth or a flat section 20 formed from a rolled sheet of the same stainless steel foil as pan section 16. The joint 22 at the edge of enclosure 10 is preferably sealed by resistance seam welding.

Although conventional stamping can be used to form pan 16, in a preferred embodiment pan 16 is draw formed using pneumatic draw forming with air, nitrogen or other inert gas to force a sheet of stainless steel foil into a die cavity (not shown). When using pneumatic forming, the range of possible stainless steel foil thicknesses is between 0.0025 to 0.0040 inches thick. Three-dimensional corners and rounded edges are preferred to minimize any cracking, tearing, or formation of pin holes in the stainless steel foil during the forming operation. Draft angle is the angle from vertical measured from the top along the side of the pan. An angle of 0 degrees is a perfectly rectangular pan. The draft angle is selected based on the application requirements as well as what is possible from a particular stainless steel foil. Deeper draws for a given angle are more severe and less forgiving of tearing and cracking. As the foil is drawn it cold-works becoming more brittle with less elongation. For example, a draw depth of 1.50″ may require a 45° draft angle whereas a draw depth of 0.75″ may be drawn at a shallower 25° draft angle.

In another preferred embodiment, joint 22 between lid 20 and pan 16 is attached using laser seam welding. In particular, as illustrated in FIG. 1A AND FIG. 1B, a foamed polymer insulation layer 24 is coated on to joint 22 to minimize heat flow and for damage protection. In addition, physical and/or chemical getters 26 are installed in the core 12 between layers of fiberglass sheets or plies 14. These getters 26 may be of the molecular sieve type, such as Linde 5A, to permanently scavenge water vapor that may outgas during the life of the panel 10. In a preferred embodiment, a small quantity of palladium oxide, typically 20 to 50 milligrams per square foot of VIP is incorporated in panel 10 to control any hydrogen that may arise from the welding process or from the fully annealed stainless steel foil in pan 16 and lid 20.

The core of the VIP of the present invention is created from wool or continuous filament type glass fibers produced from a variety of fiber forming processes and glass chemistries. The fibers can originate from processes that incorporate rotary fiberizers, flame or air blast attenuated precious or non-precious metal bushings, as well as from precious metal bushing continuous fiber processes. The glass types include all types of borosilicate, C glass, E glass, or other commonly used glass materials used to make glass fibers or filaments.

Preferably to make the core of the present invention, the glass fiber paper sheets or plies 14 are formed in what is called a “wet process” from glass fibers having a diameter of from about 0.4-8 microns. In particular, substantially clean glass fibers are mixed with water to create a slurry (or furnish) with the desired consistency (% by weight of fibers) and fiber length using a hydropulping machine such as used in papermaking. Chemical dispersants or additives (acids, bases, or surface active agents) may be blended into the slurry (at low levels below 0.2% by weight or to control pH) to further promote fiber dispersion.

The glass fibers of the present invention can be pulped to a consistency range of between 0.5% and 10.0% by weight. The fiber length can be reduced to the desired level in the hydropulping machine by action of spinning blades that serve to chop the glass fibers. The consistency and fiber length parameters determine the degree of entanglement and laminarity of the finished paper sheet or plies. Highly laminar paper sheet or plies is desirable in the preferred embodiments of the present invention.

In this process, the slurry is discharged onto a moving screen through a headbox where the water is drained away, leaving the fibers 30 in the desired tangled and laminar configuration similar to how cellulose fibers are arrayed in paper. The water on the product is then removed in a drying oven and the resultant paper sheet or ply is rolled up for later processing into the core of the present invention. The glass paper produced is substantially free of volatile organic materials that could later ruin the vacuum level of the present invention. The entanglement of the fibers produced in the wet papermaking process constitutes the fibrous structure of the paper thus imparting physical strength.

In a preferred embodiment, vacuum insulation panel 10 is formed using, for example, twenty plies of fiberglass sheet to produce a fiberglass core with a thickness of 0.75 inches when the panel 10 is subjected to a weight load of 1 atmosphere or 2117 pounds/sq. ft. The total weight of each ply is about 21.9 grams/sq. ft. and the thickness of one uncompressed ply is 0.0575 inches and the thickness of one compressed ply is 0.0375 inches.

In a preferred embodiment, hydropulped single fiberglass piece core can be used. These cores allow the use of commonly available high throughput inexpensive rotary fiberizer processed wool glass fibers from, for example, Owens Corning, Johns Manville, Knauf, or CertainTeed St. Gobain. These fibers are typically $0.30 to $0.40 per pound compared to $2.25 per pound for glass fiber paper. Glass fiber is the single highest cost ingredient of the present invention, representing over 70% of the material costs, so tremendous cost improvements are foreseen.

Glass chemistries and slow flow throughput processes used to make these glass fibers and the papers are rather expensive for mass production, limiting widespread use. Stacking these layers up and trimming them to fit the pan is also a required and costly step. A most preferred option is to produce the cores directly as disclosed in the present invention in a single piece “wet core process” that fits the pan without the stack up and trimming steps. These are called net shape single piece cores in the present invention. Most importantly, the “wet core process” allows the use of more widely available and much cheaper glass fibers formed on high throughout cheaper glass chemistry rotary fiberizer processes in the diameter ranges preferred in the present invention.

Preferably, to make the core of the present invention, the glass fiber net shape single piece glass fiber core 14 is formed directly in what is called a “wet core process” from glass fibers having a diameter of from about 0.4-8 microns. In particular, substantially clean glass fibers are mixed with water to create a slurry (or furnish) with the desired consistency (% by weight of fibers) and fiber length using a hydropulping machine such as used in papermaking. Chemical dispersants or additives (acids, bases, or surface active agents) may be blended into the slurry (at low levels below 0.2% by weight or to control pH) to further promote fiber dispersion. For glass fibers of the present invention the consistency range is between 0.5% and 10.0% by weight.

The fiber length is reduced in the hydropulping machine by action of spinning blades that serve to chop the glass fibers to further promote fiber dispersion. The consistency and fiber length parameters determine the degree of entanglement, laminarity, and uncompressed density of the finished net shape single piece glass fiber core. In this process, the slurry is discharged into an individual drainage screen mold built to the dimensions of the foil pan shape where a large amount of the water is removed. The fibers become entangled and conform to the shape of the pan as a single piece core leaving the fibers 30 in a desired tangled and laminar configuration.

The orientation of the entangled fibers is desirably and primarily laminar in that they are aligned substantially parallel to the local drainage screen mold planes. (Fibers parallel to the local screen mold planes have higher thermal resistance than fibers perpendicular). Mechanical pressure is applied to the wet glass fiber core to further reduce thickness to approach the finished VIP thickness. Air pressure of between 0 and 60 psig is then applied through a cover screen to the permeable wet core to strip off the majority of the water from the fibers. Finally, the nearly dried net shape core is ejected from the mold, dried in an oven, and stored for later use.

The net shape single piece glass fiber core produced illustrated in FIG. 1B is free of volatile organic materials that could later ruin the vacuum level of the present invention. The entanglement produced in the wet core process constitutes the physical structure of the core.

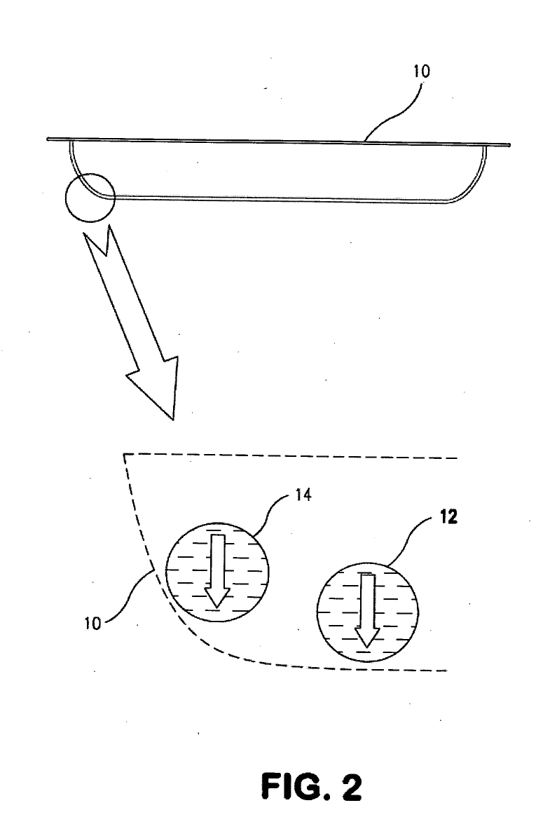

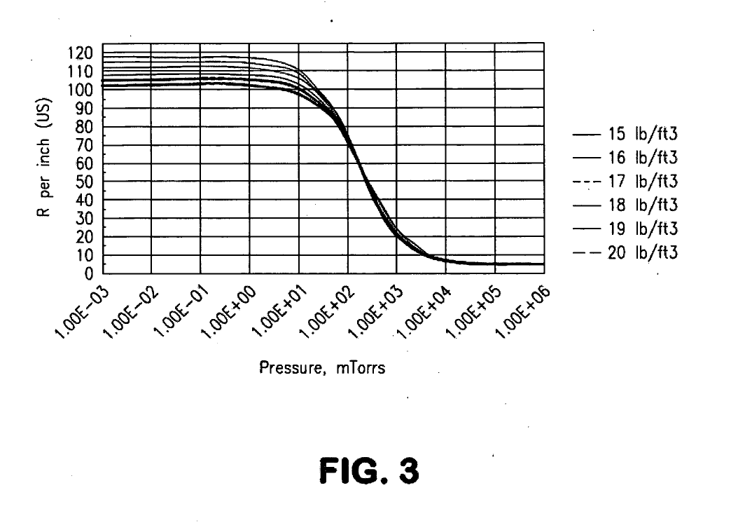

A vacuum insulation panel 10 of the present invention, FIG. 2, illustrates the fiber orientation in the exploded views taken perpendicular to the primary heat flow direction for both the net shape and piece core 14 and the laminar entangles fiber sheets 12. In FIG. 3, the R value is shown for fiberglass sheets of various weights when employed in the vacuum insulation panel of the present invention. The R per inch response can be seen in FIG. 3 to vary between about 100 and 118 depending on the compressed density under the full weight of the atmosphere. Assuming a stable pressure, the vacuum insulation panel will remain below 1.0E+00 mTorrs where the R per inch does not vary with pressure. However, the effective R value of the insulation panels of the present invention will depend on its size, the stainless steel type, stainless steel thickness, and edge detail. The effective R value will be less than the COP center of panel R value due to the shunting of heat around the panel edges. Note that whether the core is made via the fiberglass paper sheet method or net shape single piece wet core process, the COP R value is unchanged.

Flanged pans of a desired length, width, and thickness can be made from 3 mil (0.003″) thick fully annealed stainless steel foil. The grade of steel can be any of the fully annealed types such as 201L or 304L. Low carbon L type is preferred as the welds will be more resistant to corrosion. The preferred method of producing these thin foil pans is by pneumatic forming. In particular, air or nitrogen gas is introduced into a mold containing the flat foil sheet. The gas is introduced to stretch the foil into the pan shape evenly around all the edges and with radii in the mold to prevent tearing.

The gas forming process eliminates the need to clean stamping oils off the formed pan. The action of the stretching causes the foil to cold work making it stronger/tougher and changes the grain structure, reducing thermal conductivity of the foil in the critical edge area. The draft angle of the pan can be altered to lengthen the path from the hot side to the cold side or as desired to fit into the end use application better.

A lid for the pan can be cut out of the rolled foil. As a second option a formed pan could be used as a lid for very thick (>1″) panels. A glass fiber core (or any suitable core material with high enough center of panel R value) is prepared and then inserted into the pan. Preferred core materials for high performance are made of glass fibers in what is called a “wet process” similar to papermaking. A wide variety of options exist for this type of material. This material is available in rolls in a ply or paper-like form. The layers are thin, typically 0.0625″ thick. The material is available very clean, organic free, and comes in a wide variety of fiber diameters, calipers, and basis weights.

However, the glass chemistries and slow low throughput processes used to make these glass fibers and the papers are rather expensive for mass production limiting widespread use. Stacking these layers up and trimming them to fit the pan is also a required and costly step.

A most preferred option is to produce the cores directly as disclosed in the present invention in a single piece “wet core process” that fits the pan without the stack up and trimming steps. These are called net shape single piece cores and are illustrated in FIG. 1B. Most importantly the “wet core process” allows the use of more widely available and much cheaper glass fibers formed on high throughput cheaper glass chemistry rotary fiberizer processes in the diameter ranges preferred in the present invention.

Fiber diameter is a critical panel performance variable as there is an optimum tradeoff between the compression resistance (atmospheric loading) and core thermal resistivity. Typically, the layers are stacked or the net shape one piece core is formed to arrive at the correct center of panel R value when the panel is under atmospheric loading. For example, 28 layers may be required to attain a center of panel R-value of 75 in one inch. Any suitable method to cut the layers can be used to arrive at the correct core material shape to fit the pan. For example, seven axis water jet cutting can be used successfully. For example, die cutting can be used to die cut stacks to various sizes. Alternately for example, a net shape one piece core can be made by designing the proper amount of glass fiber slurry to load into the net shape mold tool to arrive at the correct thickness under atmospheric loading. A core density of 16 lb/ft³ is required, for example, weighing 1.33 lb/ft² to attain a center of panel R-value of 75 in one inch.

Chemical getters are preferably installed into the core material, usually between the laminations or within the single piece core. These can be molecular sieve type, Linde 5A, to permanently scavenge water vapor that may outgas during the life of the panel. A very small quantity of palladium oxide is needed to control any hydrogen that may arise from the welding process or from the fully annealed foil process. The quantity or amount of these items needed varies with the size of the panel.

The formed or flat lid is preferably pierced in a suitable location with a tool that forms a recess to hold the nickel braze button. This location can be just above the spot that the chemical getters are installed. The lid is installed coincident with the pan flanges. It is necessary to press down the core laminations or net shape one piece core to match the lid up with the pan flanges. It is important to prevent glass fibers from contaminating the area between the flanges and the lid. The wet laid glass plies or single piece net shape core perform better in this area than conventional OWENS CORNING® heat set glass fiber cores and cost much less.

The lid is secured hermetically to the pan flanges using a resistance seam-welding machine. Typically this machine is made by SOUTEC Soudronic®, H&H, and others. SOUTEC is preferred because it uses reusable copper wire on the copper welding wheels presenting a fresh roller electrode continuousy. The prepared assembly can then be sent to a helium leak detection station and checked to see that the welds are hermetic.

The present invention is not limited to use in wall sections of buildings but rather can be used in floors, ceilings, and roofs. Any areas of a building that can benefit from increased insulation value at low thicknesses (i.e., superinsulation). The applications are not just for buildings but could be any thermal enclosure that provides conditioned temperatures including cold or hot storage enclosures, appliances, LNG pipelines, cold or hot pipes, etc.

The VIP is sealed post evacuation by the use of the compounded nickel braze shaped button used to seal the sealing port while the panel is in the vacuum chamber. The braze button is located on top of the sealing port and does not interfere with the flow of gas and vapor out of the panel during pumpdown. When the chamber vacuum level is correct, a carbon heater located above the braze button is fired which melts the braze button. The molten braze material fills the gaps in the sealing port and the panel is sealed when cooled.

A previously prepared braze button can then be dropped into the recess on the panel assembly surface. This braze button can be made from a nickel alloy braze powder with gap filler metals containing an organic binder so that it can be made into button form in a prior step. A preferred braze button is made from a BNi-7 composition produced by Wall Colmonoy®.

The panel is preferably placed into a 600° F. convection oven for sufficient time to remove moisture or any adhered organic contaminants from the foil and glass fiber surfaces. The time will depend on the size and thickness of the intended panel.

The panel assembly, while still hot, is then placed into a vacuum chamber. This chamber contains electrical leads for a carbon heater that is placed just above the braze button. The chamber door is then closed and vacuum pumpdown is started and continued for a specified time. Once the chamber is at the correct sub-atmospheric pressure, the heater is energized to heat up the braze button. The button when molten will flow into the piercings and serve to seal this area. Once flow has occurred, the heater is turned off and a short cooling period follows. The chamber can be opened and the panel removed. Preferably, quality control testing of the panel can be done once the panel is cooled to room temperature by inserting it into a thermal conductivity tester. The processed assembly is now a vacuum insulation panel.

A quick and accurate proprietary thermal effusivity performance test developed by the inventor to arrive at COP R value (or thermal conductivity) is preferably carried out on every production panel, and can also be done in the field. This test is not conventionally performed on VIP. Thermal effusivity testing is preferred since it gives the true COP performance, and is quick and inexpensive to use. This test does not replace but rather complements the helium leak detection statistical testing that is done on the invention. Thus, 100% QC can be performed in the production plant.

The method is amenable to the construction job site as it is fast and easy to to assure 100% good panels. That would be important to the customer that the installed panels are all good. If a damaged panel is found, it is generally easy to tell if it is ventilated since the panel will be flat like a tire. But sometimes a slow leaker with minor construction damage could appear sound. The new test method can find it and determine if the performance is within specification. A thermal imaging camera system can be used to detect good/bad panels once the building is completely finished.

The present invention is then packaged for further optional processing. This further processing can consist of additional armoring, coatings or foam, to prevent construction site damage or used as is. Any sharp flange weld edges can be covered in tape to prevent injury when handling.

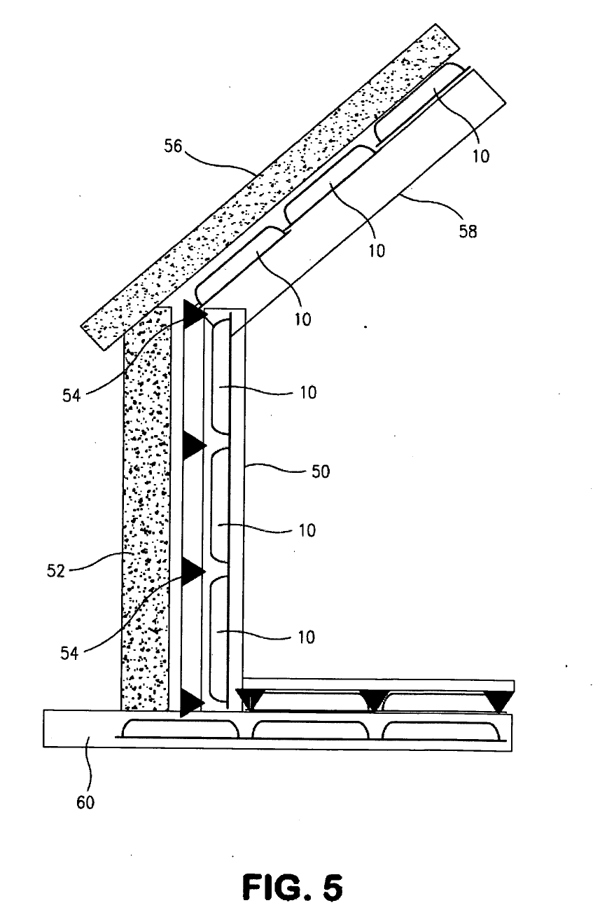

Once the vacuum insulation panels of the present invention are received on the construction site, they are installed. For example, as illustrated in FIG. 5, vacuum insulation panels 10 are disposed between the inner and outer walls 50, 52, respectively, of a masonry wall by simply sliding the vacuum insulation panels between these walls in open sections of the wall and attaching with tie elements 54. Alternatively, the vacuum insulation panels 10 may be adhered to one wall using, for example, suction cup type holders, and then the opposing wall constructed so as to encase the vacuum insulation panel 10. The use of vacuum insulation panels between the root 56 and ceiling 58 is also illustrated in FIG. 5. In addition, vacuum insulation panels 10 can also be advantageously incorporation in the footer 60, as shown in FIG. 5.

In either case, a special keeper can be used to hold the panels onto the wall during the insulating/installation process. Once the vacuum insulation panel 10 is installed, the wall is built as usual. If the application is for a multistory building façade, a different procedure is likely. The panels 10 of the present invention will need to be incorporated into the design of the façade and likely will be installed at a factory to come pre-assembled at the job site.

In a preferred embodiment of the present invention, the use of wet laid glass paper ply or most preferably a net shape one piece core that allows flexibility in designing and building vacuum panels is used. Also, the durability of the stainless steel foil will require no further secondary enclosure to protect the panel from puncture, humidity, or other damaging effects.

The use of draft angles in the pan will allow nesting for maximum wall coverage. Also, the use of medium vacuum levels will result in the thinnest possible panel with the highest effective R-values at the lowest possible cost that last 100 years.

The design of the panels will be available in a number of sizes to reduce SKUS, yet still cover the wall or application area fully. The design will outperform and outlast any conventional VIP on the market today.

Conventional stamping of the pans can be used besides the pneumatic forming described herein. Resistance seam welding of the pan and lid can be employed. However, laser welding of the pan and lid can also be used.

It is also preferred to conduct helium leak detection combined with the new proprietary thermal effusivity test for 100% quality control, thermal conductivity testing of the panel, and provide special damage resistant packaging for the shipping containers. The damage resistant packaging can be used within the cavity to be insulated to reduce waste and landfill burden or it may be fully recycled for reuse at the production location.

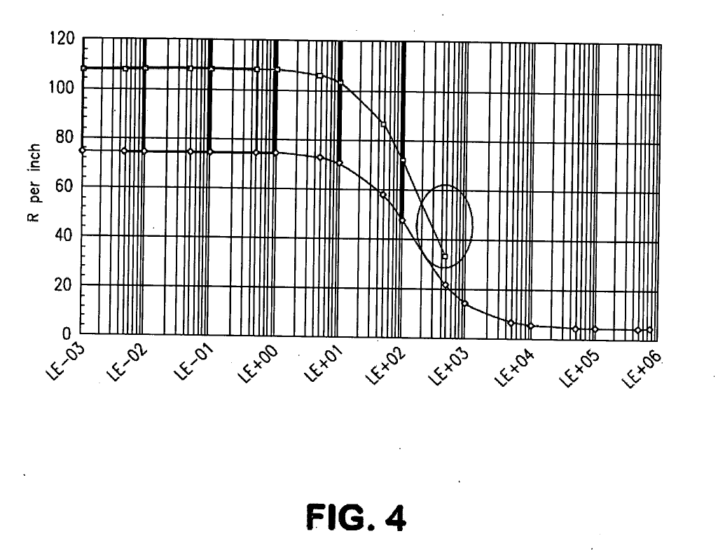

The present invention allows the use of cheaper more available fiberglass materials that superinsulate only at medium (stronger) vacuum levels (as well as the more costly fillers). For example, as illustrated in FIG. 4, it can be seen that a theoretical COP R value of the present inventive vacuum insulation panel (top curve) is much higher at low pressures than conventional vacuum insulation panels (lower curves), indicating a much lower cost of panel construction.

Combine the lower COP R per inch of conventional vacuum insulation panels with the large thermal bridging present in aluminum foil panels, and it is seen that the “effective” 56.8 R-value of conventional vacuum insulation panel is not possible at the thicknesses available in the UK masonry wall cavities. There exists a need for a thin, weather tight, long lasting, and high performance insulation within opaque facades of building worldwide to reduce energy consumption, thus reducing the global warming potential, energy consumption, and energy costs thereof. The vacuum insulation panel of the present invention has been found to be desirable, applicable, and practical for any large building exterior façade, such as those built to enclose the structural and interior elements of large buildings such as skyscrapers or multi or single story buildings.

Further, the vacuum insulation panel of the present invention is applicable and desirable for use in home construction, such as is practiced in the UK. Specifically, this invention has been found to be desirable, applicable, and practical for homes and other buildings having hollow masonry walls, which are difficult to insulation, such as those built in the UK. The present invention can improve the thermal resistance of home walls to the levels required by the new standards (typically 56.8 US R value or 10 RSI or 0.1 U value ISO), which were heretofore unattainable using conventional insulation practices in the UK. This can be done at panel thicknesses that will fit within this 4-inch gap. Thus the present invention will also allow standard UK home construction practices to prevail.

The present invention is not limited to use in wall sections of buildings but rather can be used in floors, ceilings, and roofs. Any areas of a building that can benefit from increased insulation value at low thicknesses (i.e., superinsulation). The applications are not just for buildings but could be any thermal enclosure that provides conditioned temperatures including cold or hot storage enclosures, appliances, LNG pipelines, cold or hot pipes, etc.

In the present inventions, there is a recognition of the difference between center of panel (COP) R value (R per inch is resistivity), and the effective R value. The effective R value encompasses the thermal short circuiting or “thermal bridging”, or edge effects from the envelope material. The literature concerning VIP frequently ignore this difference and just quote the COP R value or resistivity (or 1/k) which, of course, is much higher. The COP R value drives the effective R value. The effective R value is always lower than the COP R value. This is explained in great detail in the new ASTM Standard for vacuum insulation panels ASTM C 1484-01.

Also the insulation core k factor is called core thermal conductivity. Thermal resistivity is 1/k, and R value is defined as thickness divided by k factor. Therefore, the present invention takes into account thermal bridging edge effects. The value of 56.8 is an “effective R value” and was calculated from FEA to occur at thicknesses of between 1 and 2 inches for practical size panels. This performance is driven by the 75 R per inch COP thermal resistivity engine. The larger the length and width area of the VIP, the less thermal bridging effect there will be. As the product of jacket thermal conductivity K times thickness to the envelope vacuum jacket (K×T) reduces, the closer the effective R will be to COP R.

Although specific embodiments of the present invention have been disclosed herein, those having ordinary skill in the art will understand that changes can be made to the specific embodiments without departing from the spirit and scope of the invention. Thus, the scope of the invention is not to be restricted to the specific embodiments. Furthermore, it is intended that the appended claims cover any and all such applications, modifications, and embodiments within the scope of the present invention.

### LIST OF DRAWING ELEMENTS

10: vacuum insulation panel
12: core
14: multiple stacked layers of non-woven organic free fiberglass sheets or plies
16: first pan-shaped section 16
18: rounded corners 18
20: flat section (lid)
22: joint
24: foamed polymer insulation layer
26: physical and/or chemical getters
28: stainless steel outer casing
30: fibers
50: inner walls
52: outer walls
54: tie elements
56: root
58: ceiling
60: footer

What is claimed is:

1. A vacuum insulation panel comprising:
a core comprised of a plurality of stacked non-woven organic free glass fiber sheets or plies, or net shape one piece glass fiber core, and a vacuum sealed enclosure containing said core, said enclosure formed from stainless steel foil and having an effective R value of at least 56.8 at moderate vacuum levels of between about 1.0E−02 to 1.0E+01 mTorr, and a panel thickness of from about 0.50 to 2.50 inches.

2. The vacuum insulation panel of claim 1, wherein the core is formed from sheets of wet laid glass fibers or net shaped single piece glass fiber core having a nominal diameter of from about 1.5-3.0 microns, said insulation panel having an effective insulation R value of from about 56.8-107.

3. The vacuum insulation panel of claim 1, wherein the vacuum sealed enclosure is formed from fully annealed stainless steel foil.

4. The vacuum insulation panel of claim 3, wherein the vacuum sealed enclosure is formed from low carbon stainless steel foil.

5. The vacuum insulation panel of claim 4, wherein the vacuum sealed enclosure is formed from fully annealed stainless steel foil about 0.003 inches thick.

6. The vacuum insulation panel of claim 5, wherein the vacuum insulation panel enclosure is formed from a fully annealed stainless steel grade 201L or 304L.

7. The vacuum insulation panel of claim 1, wherein a portion of the vacuum sealed enclosure is formed into a pan shape by pneumatic forming using a die with curved edges and corners whereby to eliminate sharp corners and bends thus preventing tearing and formation of pin holes in the stainless steel foil.

8. The vacuum insulation panel of claim 7, wherein a lid is attached to the pan shaped portion of the enclosure by resistance seam welding.

9. The vacuum insulation panel of claim 1, wherein the vacuum sealed enclosure is formed from fully annealed stainless steel foil having a low carbon content and grade 201L or 304L, said foil being 0.003 inches thick and being formed into a pan-shaped portion of the vacuum sealed enclosure by pneumatic forming using a die with curved edges and corners, whereby to eliminate sharp corners and bends thus preventing tearing and formation of pin holes in the foil, and a lid being attached to the pan-shaped portion of the enclosure by resistance seam welding.

10. The vacuum insulation panel of claim 2, wherein the vacuum sealed enclosure is formed from fully annealed stainless steel foil having a low carbon content and grade 201L or 304L, said foil being 0.003 inches thick and being formed into a pan-shaped portion of the vacuum sealed enclosure by pneumatic forming using a die with curved edges and corners, whereby to eliminate sharp corners and bends thus preventing tearing and formation of pin holes in the foil, and a lid being flat or pan-shaped being attached to the pan-shaped portion of the enclosure by resistance seam welding.

11. The vacuum insulation panel of claim 1, wherein the core has a nominal density range of from about 12-20 lbs./ft³ under atmospheric loading.

12. The vacuum insulation panel of claim 1, wherein the production process for the glass fiber sheet or ply or net shaped single piece glass fiber core is water based.

13. The vacuum insulation panel of claim 1, wherein the glass fibers in the glass fiber sheet or ply or net shaped single piece glass fiber core can be any diameter ranging from about 0.4-8 microns.

14. The vacuum insulation panel of claim 1, wherein the glass fiber sheets or plies or net shaped single piece glass fiber core are formed by mixing short glass fibers with water to form a slurry which is then passed to a hydropulping machine to drain the water and cause the fibers to become entangled in a substantially laminar fashion in a sheet.

15. The vacuum insulation panel of claim 1, wherein the thickness of one uncompressed sheet or ply of fiberglass is from about 0.040-0.080 inches, and the thickness of one compressed ply of sheet or ply of fiberglass is from about 0.026-0.052 inches.

16. The vacuum insulation panel of claim 1, wherein said core is heated to a temperature of from about 400-600° F. to drive off water and/or organic impurities.

17. The vacuum insulation panel of claim 16, wherein the heated enclosure is evacuated to a pressure below about 1.0E to 1 mTorr.

18. The vacuum insulation panel of claim 1, wherein palladium oxide is incorporated in the panel to control any hydrogen that may outgas from the weld of the stainless steel enclosure and from the annealed stainless steel foil.

19. The vacuum insulation panel of claim 1, wherein physical and/or chemical getters are installed within the core materials to scavenge water vapor that may outgas during the life of the panel.

20. The vacuum insulation panel of claim 1, wherein outer edges of the panel at welds are coated with a layer of insulating foam to minimize heat flow and protect from damage.

21. A method of producing a vacuum insulation panel comprising:
(a) providing a core comprised of a plurality of stacked non-woven organic free fiberglass sheets or plies or net shape single piece glass fiber core with entangled laminar oriented glass fibers;
(b) introducing said core into a pan-shaped enclosure formed from stainless steel foil; and
(e) evacuating and sealing said enclosure.

22. The method of claim 21, wherein said nonevacuated unsealed core and welded pan assembly is heated prior to being inserted into said enclosure.

23. The method of claim 21, wherein palladium oxide and a physical desicant getter and/or chemical getter is inserted into said enclosure prior to heating, evacuating, and sealing said enclosure.

24. The method of claim 21, wherein said core assembly enclosure is heated to a temperature between about 400-600° F. prior to evacuating and sealing.

25. The method of claim 22, wherein said enclosure is evacuated to a pressure between about 1.0E−02 to 1.0E−01 mTorr.

26. The method of claim 21, wherein said glass fibers have a nominal diameter of from about 2.0-3.0 microns.

27. The method of claim 21, wherein the vacuum insulation panel is rectangular or square shaped or any substantially flat panel geometry and has a thickness of from about 0.50 to 2.50 inches.

28. A method of construction comprising disposing the vacuum insulation panel of claim 1 between two adjacent walls having a gap therebetween.

29. The method of construction of claim 28, further comprising disposing a filler material within the gap, so as to partially or fully encase the vacuum insulation panel therein.

30. The method of construction of claim 29, wherein the filler material is one or more of aerated concrete, concrete, brick, foam insulation, plywood, building exterior or interior facades.

31. The vacuum insulation panel of claim 1, wherein the core comprises a one piece wet molded glass fiber core.
